(19) United States
(12) Patent Application Publication
(10) Pub. No.: US 2006/0049583 A1
(43) Pub. Date: Mar. 9, 2006

(54) Oil-control ring of piston

(75) Inventor: Wan-Chieh Lu, Tainan (TW)

Correspondence Address: NIKOLAI & MERSEREAU, P.A., 900 SECOND AVENUE SOUTH, SUITE 820, MINNEAPOLIS, MN, 55402, US

(73) Assignee: C.T.I. Traffic Industries Co., Ltd., Tainan (TW)

(21) Appl. No.: 10/935,861

(22) Filed: Sep. 8, 2004

(51) Int. Cl. F16J 9/00

(52) U.S. Cl. 277/434

(57) ABSTRACT

Provided is an oil-control ring mounted around a ring-groove of a piston of a gasoline engine. The oil-control ring comprises an upper first thin ring having a gap, an upper second thin ring having a gap, a lower first thin ring having a gap, a lower second thin ring having a gap, and an intermediate main ring, wherein the gap of the upper first thin ring is not aligned with the gap of the upper second thin ring and the gap of the lower first thin ring is not aligned with the gap of the lower second thin ring. A plurality of embodiments of the main ring are made possible.

### FIELD OF THE INVENTION

The present invention relates to oil-control rings of piston and more particularly to such an oil-control ring of piston of gasoline engine with improved characteristics.

### BACKGROUND OF THE INVENTION

A conventional oil-control ring 20 comprises an upper thin ring 30, a lower thin ring 40, and an intermediate main ring 50 and is placed around a ring-groove of a piston 10 of an engine is shown in FIGS. 1 and 2. However, fluid in the combustion chamber of the engine may escape through gaps 301 and 401 due to wearing of the cylinder and the rings 30, 40, and 50 after a relatively long period time of use of the engine. And in turn, it may cause an incomplete combustion. As a result, a sufficient torque cannot be generated. Hence, a need for improvement exists.

### SUMMARY OF THE INVENTION

It is an object of the present invention to provide an oil-control ring mounted around a ring-groove of a piston of a gasoline engine, comprising an upper first thin ring having a gap; an upper second thin ring having a gap; a lower first thin ring having a gap; a lower second thin ring having a gap; and an intermediate main ring, wherein the gap of the upper first thin ring is not aligned with the gap of the upper second thin ring and the gap of the lower first thin ring is not aligned with the gap of the lower second thin ring.

In a first aspect of the present invention, the main ring comprises a plurality of units each having two mated hook sides either coupled to the mated hook side of an adjacent unit, and a hollow central portion.

In a second aspect of the present invention, the main ring comprises a plurality of units and a ring member for coupling the units together.

In a third aspect of the present invention, the main ring comprises a plurality of integral units each having a circular hole.

In a fourth aspect of the present invention, the main ring comprises a plurality of wavy integral units.

In a fifth aspect of the present invention, the main ring comprises a plurality of integral units each having a hollow central portion.

In a sixth aspect of the present invention, the main ring comprises a plurality of units each having a flat outer, rectangular section and two pairs of legs each being integrally formed with an adjacent unit.

The above and other objects, features and advantages of the present invention will become apparent from the following detailed description taken with the accompanying drawings.

### BRIEF DESCRIPTION OF THE DRAWINGS

FIG. 1 is an exploded view of a conventional oil-control ring to be mounted around a piston;

FIG. 2 is a schematic side view of the assembled oil-control ring and the piston in part section of FIG. 1;

FIG. 3 is an exploded view of an oil-control ring according to the invention to be mounted around a piston;

FIG. 4 is a schematic side view of the assembled oil-control ring and the piston in part section of FIG. 3; and

FIGS. 5, 6, 7, 8, 9, 10, and 11 are schematic perspective views of first, second, third, fourth, fifth, sixth, and seventh preferred embodiments of the main ring of the oil-control ring according to the invention respectively.

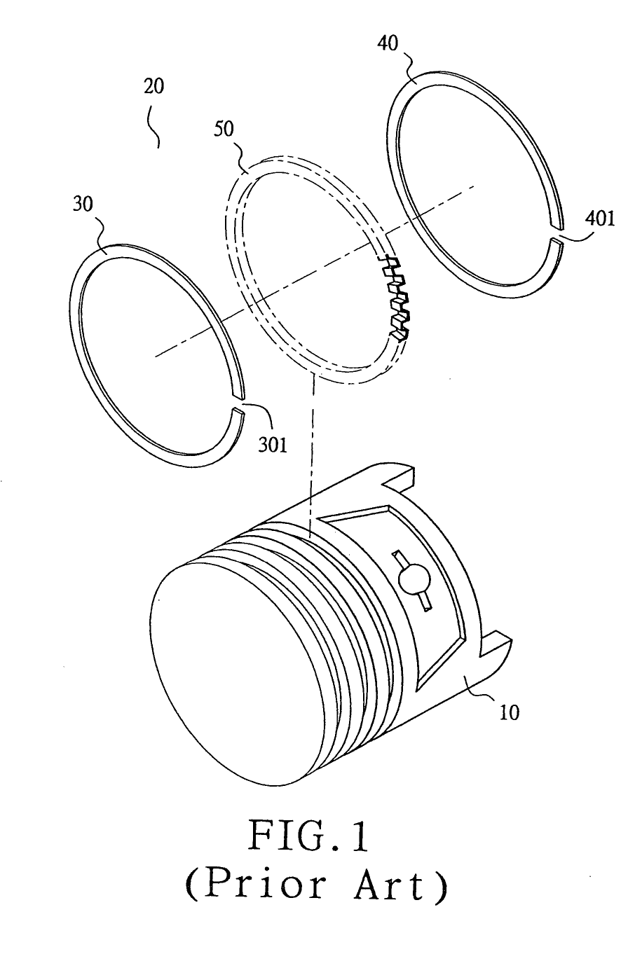

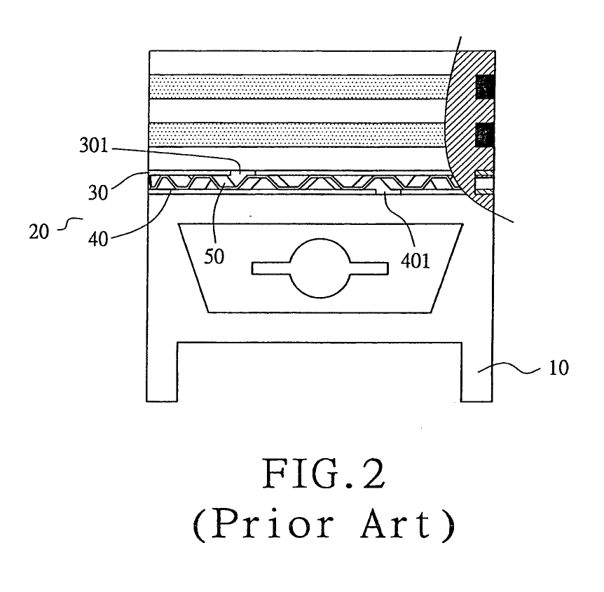

### DETAILED DESCRIPTION OF THE PREFERRED EMBODIMENTS

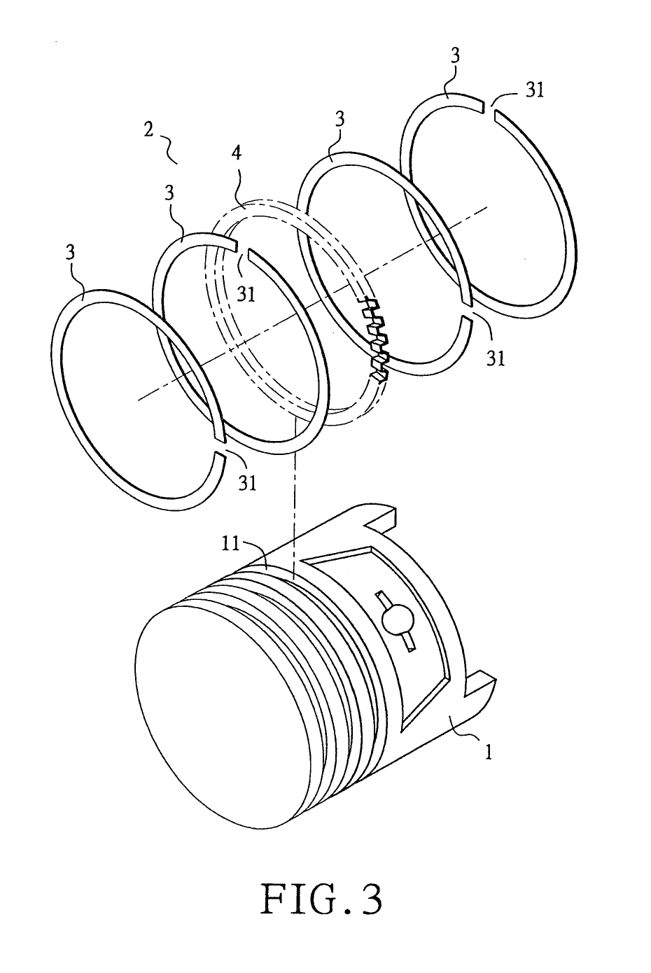

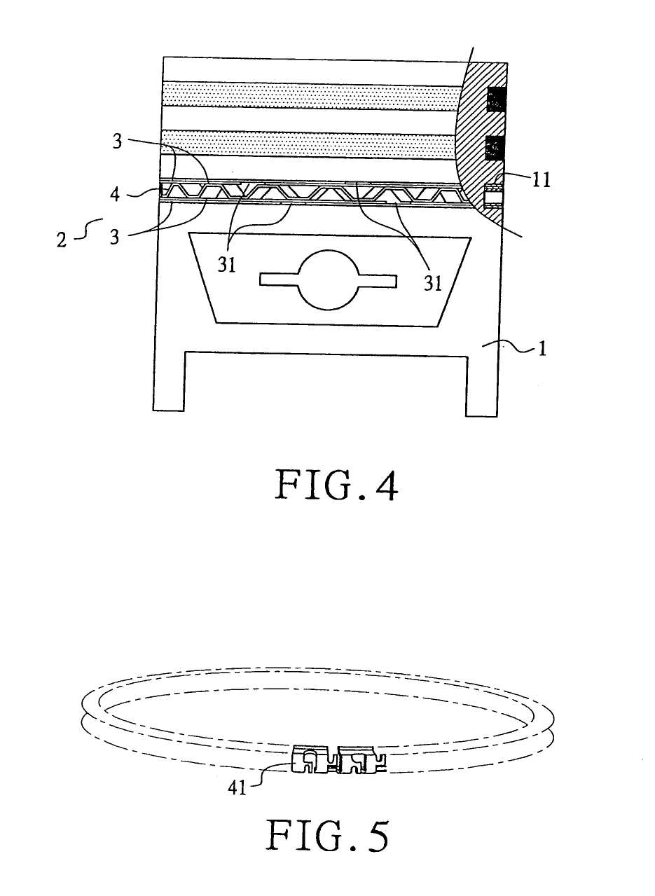

Referring to FIGS. 3 and 4, there is shown an oil-control ring 2 constructed in accordance with the invention comprising an upper first thin ring 3, an upper second thin ring 3, a lower first thin ring 3, a lower second thin ring 3, and an intermediate main ring 4. The oil-control ring 2 is placed around a ring-groove 11 of a piston 1 of a gasoline engine. A gap 31 of the upper first thin ring 3 is not aligned with a gap 31 of the upper second thin ring 3. Also a gap 31 of the lower first thin ring 3 is not aligned with a gap 31 of the lower second thin ring 3. By configuring as above, an airtight combustion chamber can be achieved. It is envisaged that fluid in the combustion chamber is substantially prevented from escaping through the gaps 31 even wearing of the cylinder and the rings 3 and 4 is serious after a relatively long period time of use.

Referring to FIG. 5, the main ring constructed according to a first preferred embodiment of the invention comprises a plurality of units 41 each having two mated hook sides either coupled to a mated hook side of an adjacent unit 41, and a hollow central portion.

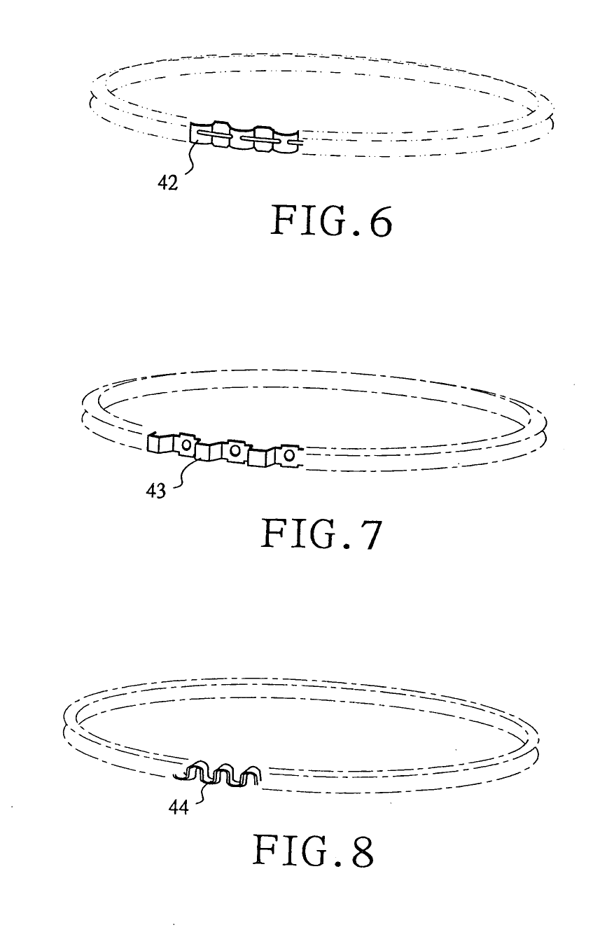

Referring to FIG. 6, the main ring constructed according to a second preferred embodiment of the invention comprises a plurality of units 42 coupled together by means of a ring member.

Referring to FIG. 7, the main ring constructed according to a third preferred embodiment of the invention comprises a plurality of integral units 43 each having a circular hole.

Referring to FIG. 8, the main ring constructed according to a fourth preferred embodiment of the invention comprises a plurality of wavy integral units 44.

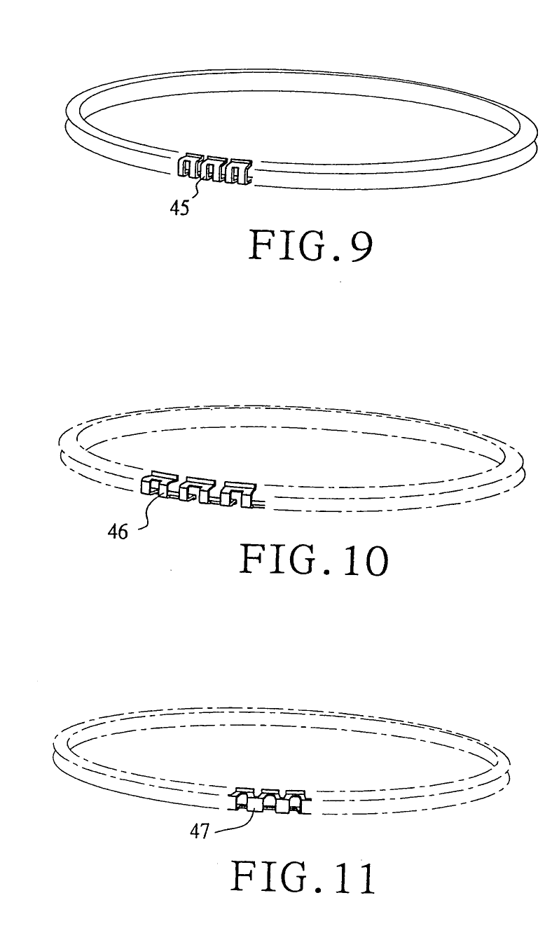

Referring to FIG. 9, the main ring constructed according to a fifth preferred embodiment of the invention comprises a plurality of integral units 45 each having a hollow central portion having a first width.

Referring to FIG. 10. The main ring constructed according to a sixth preferred embodiment of the invention comprises a plurality of integral units 46 each having a hollow central portion having a second width longer than the first width.

Referring to FIG. 11, the main ring constructed according to a seventh preferred embodiment of the invention comprises a plurality of units 47 each having a flat outer, rectangular section and two pairs of legs each being integrally formed with an adjacent unit 47.

While the invention herein disclosed has been described by means of specific embodiments, numerous modifications and variations could be made thereto by those skilled in the art without departing from the scope and spirit of the invention set forth in the claims.

What is claimed is:

1. An oil-control ring mounted around a ring-groove of a piston of a gasoline engine, comprising:
an upper first thin ring having a gap;
an upper second thin ring having a gap;
a lower first thin ring having a gap;
a lower second thin ring having a gap; and
an intermediate main ring,
wherein the gap of the upper first thin ring is not aligned with the gap of the upper second thin ring and the gap of the lower first thin ring is not aligned with the gap of the lower second thin ring.

2. The oil-control ring of claim 1, wherein the main ring comprises a plurality of units each having two mated hook sides either coupled to the mated hook side of an adjacent unit, and a hollow central portion.

3. The oil-control ring of claim 1, wherein the main ring comprises a plurality of units and a ring member for coupling the units together.

4. The oil-control ring of claim 1, wherein the main ring comprises a plurality of integral units each having a circular hole.

5. The oil-control ring of claim 1, wherein the main ring comprises a plurality of wavy integral units.

6. The oil-control ring of claim 1, wherein the main ring comprises a plurality of integral units each having a hollow central portion.

7. The oil-control ring of claim 1, wherein the main ring comprises a plurality of units each having a flat outer, rectangular section and two pairs of legs each being integrally formed with an adjacent unit.
